(19) United States
(12) Patent Application Publication
(10) Pub. No.: US 2005/0254222 A1
(43) Pub. Date: Nov. 17, 2005

(54) Hard disk drive interface device for industrial computers

(75) Inventor: Shun Ying Liang, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: T-Win Sheet Metal Co., Ltd.

(21) Appl. No.: 10/815,696

(22) Filed: Apr. 2, 2004

(30) Foreign Application Priority Data
Mar. 8, 2004 (TW) 093203464

(51) Int. Cl. G06F 1/26; G06F 1/28; G06F 1/30; H01R 12/16

(52) U.S. Cl. 361/788

(57) ABSTRACT

This invention relates to a hard disk drive interface device for facilitating the integration of industrial computer hard disk drives with a hard disk control center of an industrial computer, characterized in that a main interface circuit designed as a mother-daughter interface circuit is built at the rear end of the hard disk drive in the industrial computer to cater to changes or expansions of circuit functions by changing the daughterboard only without having to create a new layout for the motherboard every time there is a change or an expansion on the circuit functions. Further, an electric cable-retaining hook is built on the interface frame for preventing the electric cable from drooping, which will affect the quality of signal connection.

### FIELD OF THE INVENTION

The present invention relates to a hard disk drive interface device for industrial computers, more particularly to a hard disk drive for an industrial computer having an interface frame disposed at the rear end of the hard disk drive and a mother-daughter interface circuit board for changing or expanding the functions of the circuit board by changing the daughterboard only; and a cable retaining hook disposed on the interface frame for preventing the electric cable from drooping due to its weight, which may affect the quality of signal connection.

### BACKGROUND OF THE INVENTION

As we know, an industrial computer is built for processing and storing huge data, and thus the industrial computer has more hard disk drives and complicated disk control functions inside. The industrial computer also has the feature of a dedicated control center for controlling all hard disk drives in the computer.

In general, an industrial computer handles several hard disk drives by installing a hard disk drive interface frame 1 at the rear end of the hard disk drive in the industrial computer and mounting a plurality of main interface circuit boards 2 (which is referred to as interface motherboard in this invention) onto the frame. A plurality of hard disk drive connectors 21 is disposed on the main interface circuit board for connecting three or four hard disk drives 3 directly. The circuit on the main interface circuit board integrates the circuits of all hard disk drives, and the connector on the main interface circuit is connected to the control center of the industrial computer by an electric cable 4.

As described above, since the industrial computer has several hard disk drives and special control functions, therefore it is necessary to change or expand the functions or specific circuits for the requirements of practical applications. In the past, the circuits of several hard disk drives were integrated and the circuits having special functions were built on the main interface circuit board. However, once a control function or a specific circuit is changed or expanded, it is necessary to create a new layout for the main interface circuit board 2. The cost of creating a new layout for the main interface circuit board 2 is high, and the process is tedious and annoying. Such handling methods are definitely not very good ones.

Further, the traditional main interface circuit board 2 in an industrial computer is connected to a hard disk drive control center by a connector through an electric cable 4. Therefore, the electric cable 4 is perpendicular to the hard disk drive interface frame 1, and the electric cable 4 is suspended in the air and extended in the computer housing, and thus occupying much of the limited space in the industrial computer, and the electric cable 4 will droop due to its weight and affect the quality of signal connection.

In view of the foregoing shortcomings, the inventor of the present invention intended to overcome them by designing a hard disk drive interface device for industrial computers according to the present invention. The invention is characterized in that a mother-daughter interface circuit board is disposed on the interface frame at a rear end of the hard disk drive of an industrial computer to change or expand the functions of the circuit board by changing the daughterboard only, and it is not necessary to change the basic interface motherboard that integrates the circuits of each hard disk drive; the daughterboard can make partial modifications according to different requirements to provide various functions such as the I²C Controller function and the Port-Multiplier function. The present invention can shorten the product development time and lower the development or manufacturing costs.

In the structure of the present invention, an electric cable-retaining hook is designed on the interface frame 1, so that the electric cable is hung parallel with the hard disk drive interface frame 1. Such a method can prevent the electric cable from occupying too much of the limited space and prevent the electric cable from drooping due to its weight which will affect the quality of signal connection.

### SUMMARY OF THE INVENTION

The primary objective of the present invention is to provide a hard disk drive for an industrial computer comprising an interface frame disposed at the rear end of the hard disk drive and a mother-daughter interface circuit board for changing or expanding the functions of the circuit board by changing the daughterboard only; and a cable retaining hook disposed on the interface frame for preventing the electric cable from drooping due to its weight, which may affect the quality of signal connection.

### BRIEF DESCRIPTION OF THE DRAWINGS

FIG. 1 is an exploded view of the main structure of the present invention.

FIG. 2 is a perspective view of the disassembled parts including the interface motherboard, daughterboard, 4-channel infini-band cable assembly, and electric cable according to the present invention.

FIG. 3 is a front view of an installed hard disk drive according to a preferred embodiment of the present invention.

### DETAILED DESCRIPTION OF THE PREFERRED EMBODIMENTS

The detailed description and technical characteristics of the present invention are described together with the drawings as follows.

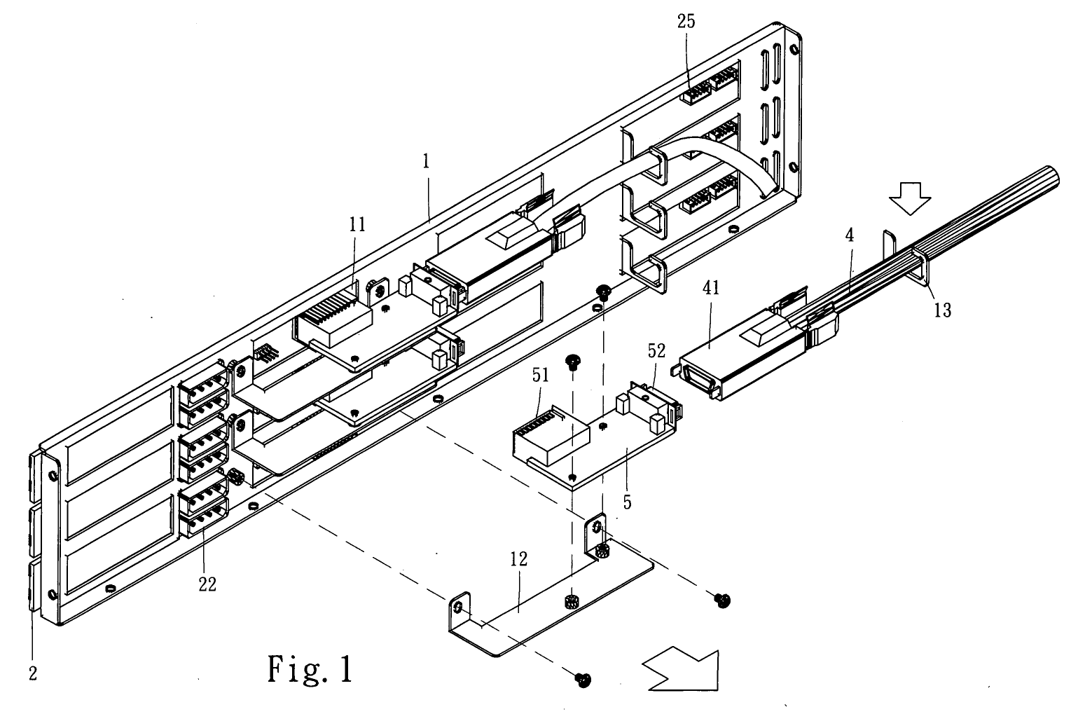

Please refer to FIG. 1 for the hard disk drive interface frame 1 according to the present invention. The interface frame 1 comprises a plurality of penetrating holes 11 disposed thereon; a retaining board 12 and a retaining hook 13 disposed on the back side, and an interface motherboard 2 mounted onto the front side of the hard disk drive interface frame 1.

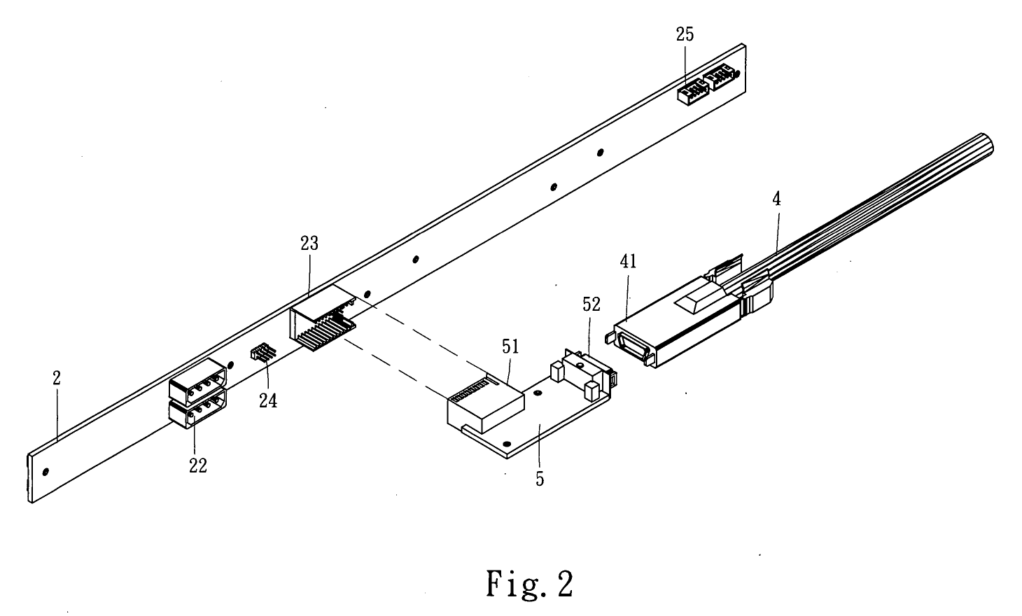

Please refer to FIG. 2. The present invention adopts the design of a mother-daughter interface circuit board, which comprise an interface motherboard 2 and an interface daughterboard 5, and the interface motherboard 2 is disposed adjacent to the front side of a hard disk drive (HDD) 3 and has a hard disk drive connector 21 for directly connecting the hard disk drive 3 to the interface motherboard 2.

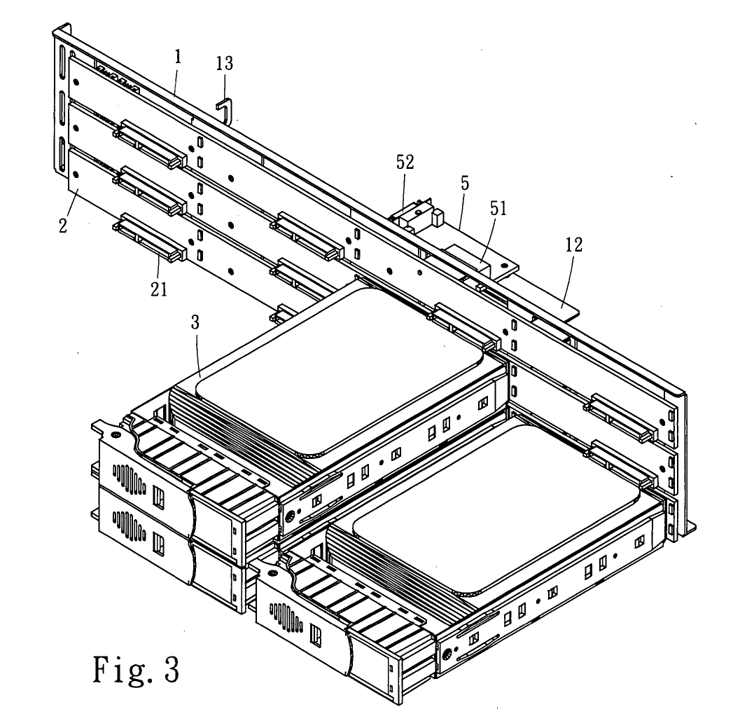

In FIG. 3, a power supply connector 22, a signal connector 23 (such as a high speed connector or its equivalents), and related connecting terminals 24, 25 are installed on the other side of the interface motherboard 2 and extended from the plurality of penetrating holes 11 of the foregoing hard disk drive interface frame 1 to the rear side of the hard disk drive interface frame 1.

A daughterboard 5 is mounted on the retaining board 12 on the rear side of the abovementioned hard disk drive interface frame 1, and a symmetric signal connector (high-speed connector) 51 is also disposed on one side of the daughterboard 5 for connecting to the signal connector 23 of the abovementioned interface motherboard 2, and a 4-channel infini-band cable assembly 52 is connected to a 4-channel multilane connector 41 at an end of the electric cable (the 4-channel infini-band cable) 4 and mounted on the parallel side of the daughterboard 5 for connecting all hard disk drives 3 on the interface motherboard 2 and the signals and functions of the daughterboard 5 through the electric cable 4 and the control center (not shown in the figure) of the industrial computer.

Herewith, if it is necessary to change or expand the functions of the circuit boards in the industrial computer, we only need to change or expand the daughterboard 5 without changing the interface motherboard 2 which integrates the circuits of each hard disk drive; the daughterboard 5 can make partial changes according to different requirements to provide various functions such as the functions of I²C Controller and Port-Multiplier as to shorten the product development time and lower the development and manufacturing costs.

The retaining hook 13 disposed on the back side of the foregoing hard disk interface frame 1 can retain and latch the electric cable 4, so that the electric cable 4 can be hung parallel to the hard disk drive interface frame 1 to enhance the stability of signal transmissions. Such a method prevents the electric cable 4 from occupying too much space and also prevents the electric cable 4 from drooping due to its weight which will affect the quality of signal connection.

In the hard disk drive interface device of the present invention, a plurality of interface motherboards 2 is mounted onto the foregoing hard disk drive interface frame 1, and the daughterboard 5, retaining board 12, and retaining hook 13 are installed according to the quantity of the motherboards 2 to achieve the effect of only changing or expanding the daughterboard 5 for changing or expanding the functions of the circuit board in the industrial computer. It is not necessary to change the interface motherboard 2 that integrates the circuits of all hard disk drives; the daughterboard can make various partial changes according to different requirements to provide diversified functions, shorten product development time, and lower the development or manufacturing costs.

The present invention can also keep the electric cable 4 hanging parallel to the hard disk drive interface frame 1 to enhance the stability of signal transmissions and save the space occupied by the electric cable 4 and prevent the electric cable 4 from drooping due to its weight which will affect the quality of signal connection.

In the hard disk drive interface device of the present invention, the 4-channel infini-band cable assembly 52 on the daughterboard 5 and the 4-channel multilane connector 41 at an end of the electric cable 4 are not limited to such, but any equivalent connectors can be used.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A hard disk interface device for industrial computers, characterized in that a mother-daughter interface circuit board is disposed on an interface frame at a rear end of a hard disk drive in an industrial computer, such that if it is necessary to selectively change and expand the functions of said circuit board, only said daughter board is needed to change; and an electric cable retaining hook is disposed on said interface frame to prevent said electric cable from drooping due to its weight which results an adverse affection to the quality of signal connections.

2. The hard disk interface device for industrial computers of claim 1, wherein said hard disk drive interface frame comprises a plurality of penetrating holes thereon, a retaining board and a retaining hook are disposed at a back side of said interface frame; and said mother-daughter circuit board comprises an interface motherboard and a daughterboard, and said interface motherboard is disposed adjacent to a surface of said hard disk drive and has a hard disk drive connector for directly connecting said hard disk drive to said interface motherboard; a power supply connector, a signal connector, and related connecting terminal are disposed on the other side of said interface motherboard, and said power supply connector, signal connector and related connecting terminals are extended from said plurality of penetrating holes of said hard disk drive interface frame to said back side of said hard disk drive interface frame, and said daughterboard is mounted on said retaining board disposed on the back side of said hard disk drive interface frame, and a symmetric signal connector is disposed on a side of said daughterboard for connecting to said signal connector disposed on said interface motherboard and a 4-channel multilane connector is mounted onto a parallel side of said daughterboard for connecting a 4-channel infini-band cable assemble at an end of said electric cable, so that all hard disk drives of said interface motherboard and the signal and function of said daughterboard are connected to a control center of said industrial computer.

3. The hard disk interface device for industrial computers of claim 1, wherein said retaining hook disposed on the back side of said hard disk drive interface frame hangs said electric cable parallel to said hard disk drive interface frame to enhance the stability of signal transmissions, and thus preventing said electric cable from occupying too much space and preventing said electric cable from drooping due to its weight which results an adverse affection to signal connections.

4. The hard disk interface device for industrial computers of claim 1, wherein said 4-channel multilane connector disposed on said daughterboard and said 4-channel infini-band cable assembly disposed at an end of said electric cable are not limited to such, but any equivalent connector can be used.

5. The hard disk interface device for industrial computers of claim 1, wherein said hard disk drive interface frame comprises a plurality of interface motherboards, and said daughterboard, retaining board, and retaining hook are installed according to the quantity of said motherboards to achieve the installation of a plurality of mother-daughter interface circuit boards.
